(19) United States
(12) Patent Application Publication
(10) Pub. No.: US 2026/0267526 A1
(43) Pub. Date: Sep. 10, 2026

(54) STORAGE SYSTEM AND STORAGE CONTROL METHOD

(71) Applicant: Hitachi Vantara, Ltd., Yokohama-shi (JP)

(72) Inventors: Shintaro ITO, Tokyo (JP); Taisuke ONO, Tokyo (JP); Sachie TAJIMA, Tokyo (JP); Yoshinori OHIRA, Tokyo (JP)

(21) Appl. No.: 19/320,119

(22) Filed: Sep. 5, 2025

(30) Foreign Application Priority Data
Mar. 7, 2025 (JP) 2025-036590

(51) Int. Cl. G06F 3/06

(52) U.S. Cl. CPC G06F 3/0619; G06F 3/0659; G06F 3/067

(57) ABSTRACT

To provide a storage system including: a non-volatile storage device; a storage controller configured to process reading and writing of data and to input and output the data to and from the storage device; and a volatile memory, in which the storage controller selectively executes a write-back operation and a write-through operation, common order guarantee information is assigned to a cache data log in the write-back operation and data related to a write request in the write-through operation, and the cache data log in the memory is recovered using the order guarantee information when recovering from power interruption.

### CROSS-REFERENCE TO RELATED APPLICATION

The present application claims priority from Japanese application JP2025-036590, filed on Mar. 7, 2025, the content of which is hereby incorporated by reference into this application.

### BACKGROUND OF THE INVENTION

### 1. Field of the Invention

The present invention relates to a storage system and a storage control method.

### 2. Description of Related Art

In related art, a redundant configuration is adopted in a storage system in order to improve availability and reliability.

For example, PTL 1 discloses the following storage system.

In a storage system including a plurality of storage nodes, each of the plurality of storage nodes includes one or a plurality of storage devices that respectively provide a storage area, and one or a plurality of storage controllers that read and write requested data from and to the corresponding storage device in response to a request from a higher-level device. Each of the storage controllers retains predetermined configuration information required for reading and writing the requested data from and into the corresponding storage device in response to the request from the higher-level device. A variety of control software is managed as a redundancy group, and the configuration information retained in each control software belonging to the same redundancy group is synchronously updated. The variety of control software configuring the redundancy group is deployed in respectively different storage nodes to distribute a load of each of the storage nodes.

In order to improve performance and reliability in such a storage system, it is required to efficiently execute non-volatility on various types of data. Therefore, as a method of efficiently storing control information, cache data, and the like of a storage system in a storage device, there is disclosed a method in which, in a storage system including a non-volatile storage device, a storage controller that controls reading and writing from and to the storage device, and a memory, the storage controller generates a log and stores the log in a log memory, and writes the log stored in the memory to the storage device at the time of the reading and writing, the log includes a control information log and a cache data log, and when the log is generated, the storage controller stores the generated control information log in the log memory, collectively writes the generated control information log to the storage device in units of storage areas having a plurality of control information logs, stores the generated cache data log in the log memory, compresses the cache data in the log memory, and writes the compressed cache data to the storage device (for example, see PTL 2).

### Citation List

### Patent Literature

PTL 1: JP2019-101703A

PTL 2: JP2023-152247A

### SUMMARY OF THE INVENTION

In the related art, in a write I/O process, the user data is written to a storage device as a cache data log, and then is also written (destaged) to a permanent area after a response to a host, and therefore, writing of the user data to the storage device occurs a plurality of times when write I/O is executed once. Therefore, a back-end bandwidth may become a bottleneck, and write performance decreases. In addition, when redundancy is executed between nodes for both the writing to the storage device as the cache data log and the writing to the permanent area after the response to the host, data transfer via an inter-node network is also executed a plurality of times per write I/O, and thus a network bandwidth may become a bottleneck and the write performance may decrease.

In order to implement the above object, one representative storage system according to the invention is a storage system including: a non-volatile storage device; a storage controller configured to process reading and writing of data and to input and output the data to and from the storage device; and a volatile memory, in which upon receiving a write request for data from a host, the storage controller selectively executes a write-back operation of creating a cache data log of the data related to the write request, writing the cache data log to a log area on the storage device, responding to the host, and destaging the cache data log to a permanent area on the storage device, and a write-through operation of destaging the data related to the write request to the permanent area on the storage device without writing the cache data log to the storage device, and then returning a response to the host, common order guarantee information is assigned to the cache data log in the write-back operation and to the data related to the write request in the write-through operation, and the cache data log in the memory is recovered using the order guarantee information when recovering from power interruption.

In addition, one representative storage control method according to the invention is a storage control method for a storage system including a non-volatile storage device, a storage controller configured to process reading and writing of data and to input and output the data to and from the storage device, and a volatile memory, the storage control method including: upon receiving a write request for data from a host, by the storage controller selectively executing a write-back operation of creating a cache data log of the data related to the write request, writing the cache data log to a log area on the storage device, responding to the host, and destaging the cache data log to a permanent area on the storage device, and a write-through operation of destaging the data related to the write request to the permanent area on the storage device without writing the cache data log to the storage device, and then returning a response to the host; assigning common order guarantee information to the cache data log in the write-back operation and to the data related to the write request in the write-through operation; and recovering the cache data log in the memory using the order guarantee information when recovering from power interruption.

According to the invention, a storage system having both high performance and high reliability can be implemented.

### BRIEF DESCRIPTION OF THE DRAWINGS

FIG. 1 illustrates an overall configuration of a storage system;

FIG. 2 is a diagram illustrating an example of a physical configuration of a storage node;

FIG. 3 is a diagram illustrating an example of a logical configuration of the storage node;

FIG. 4 is a diagram illustrating an outline of the storage system and a storage control method;

FIG. 5 is a diagram illustrating an example of a configuration of a memory;

FIG. 6 is a diagram illustrating an example of a configuration of a storage device;

FIG. 7 is a diagram illustrating an example of a software module structure of a storage controller;

FIG. 8 is a diagram illustrating an example of a cache directory;

FIG. 9 is a diagram illustrating a structure of a log header;

FIG. 10 is a diagram illustrating a structure of a unconfirmed metadata management table;

FIG. 11 is a flowchart of a read process;

FIG. 12 is a flowchart of a write process;

FIG. 13 is a flowchart of an asynchronous destage process;

FIG. 14 is a flowchart of a control information update process;

FIG. 15 is a flowchart of a cache data update process;

FIG. 16 is a flowchart of a write-through condition determination process;

FIG. 17 is a flowchart of a preliminary confirmation process;

FIG. 18 is a flowchart of a log creation process;

FIG. 19 is a flowchart of a synchronous destage process;

FIG. 20 is a flowchart of a control information confirmation process;

FIG. 21 is a flowchart of a log saving process;

FIG. 22 is a flowchart of a cache data log garbage collection process.

FIG. 23 is a flowchart of a write-through log header list garbage collection process.

FIG. 24 is a flowchart of a log recovery process; and

FIG. 25 illustrates a modification of sequence number retention.

### DESCRIPTION OF EMBODIMENTS

Hereinafter, an embodiment of the invention will be described in detail with reference to the drawings. The embodiment relates to, for example, a storage system including a plurality of storage nodes in each of which one or more software-defined storages (SDS) are implemented.

In the disclosed embodiment, the storage node stores control information and cache data on a memory. The storage node includes a non-volatile device. When the storage node updates the control information or data in response to a write request from a host, the storage node stores the data to be updated in a log format in the non-volatile device and responds to the host. At this time, the control information and the data are stored in an append format. It is necessary to reclaim a free space for storing the control information and the data in the append format.

The disclosed system selectively uses two types of methods for reclaiming the free space: a base image saving method and a garbage collection method. The base image saving method is a method of writing the whole of a certain target area of control information or cache data to a non-volatile device and discarding (reclaiming as the free space) all update logs in the target area. The garbage collection method is a method of reclaiming a log area by identifying an unnecessary log that is not the latest among update logs in a target area and transferring logs other than the unnecessary log to an area other than the target area. When power is restored, the non-volatile control information and cache data are restored to the memory. By selectively using both methods to reclaim the free space, management information required for managing the free space can be reduced, overhead for reclaiming the free space can be reduced, and storage performance can be improved.

### Embodiment 1

### 1. Embodiment 1

### 1-1. Configuration of Storage System According to Embodiment 1

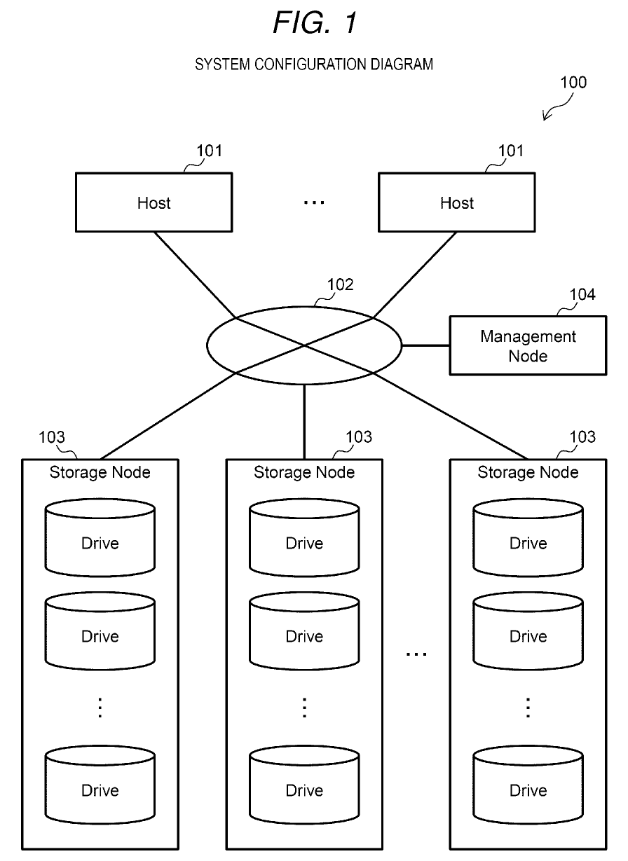

FIG. 1 illustrates the storage system according to Embodiment 1 as a whole.

A storage system 100 includes, for example, a plurality of host devices 101 (Host), a plurality of storage nodes 103 (Storage Node), and a management node 104 (Management Node). The host devices 101, the storage nodes 103, and the management node 104 are connected to one another via a network 102 implemented by a fiber channel, Ethernet (registered trademark), a local area network (LAN), and the like.

The host device 101 is a general-purpose computer device that transmits a read request or a write request (hereinafter, collectively referred to as an input/output (I/O) request) to the storage nodes 103 in response to a user operation or a request from an installed application program or the like. The host device 101 may be a virtual computer device such as a virtual machine.

The storage node 103 is a computer device that provides, to the host device 101, a storage area for reading and writing data. The storage node 103 is, for example, a general-purpose server device.

The management node 104 is a computer device used by a system administrator to manage the entire storage system 100. The management node 104 manages the plurality of storage nodes 103 as a group called a cluster. FIG. 1 illustrates an example in which only one cluster is provided, but a plurality of clusters may be provided in the storage system 100.

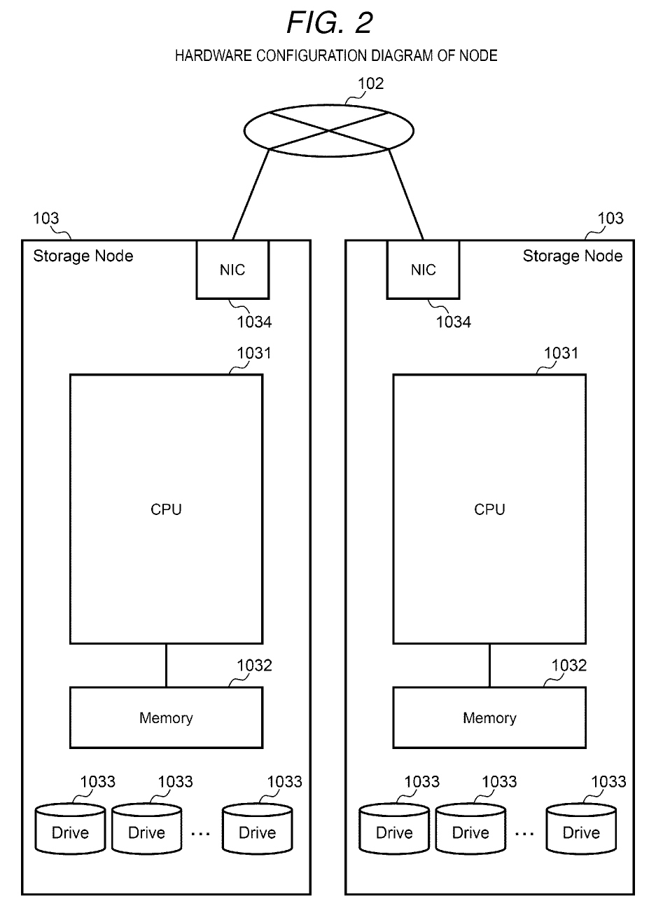

FIG. 2 is a diagram illustrating an example of a physical configuration of the storage node 103.

The storage node 103 includes a central processing unit (CPU) 1031, a memory 1032, a plurality of storage devices 1033 (Drive), and a communication device 1034 (network interface card, NIC).

The CPU 1031 is a processor that controls an operation of the entire storage node. The memory 1032 is implemented by a semiconductor memory such as a static random access memory (RAM) (SRAM) and a dynamic RAM (DRAM). The memory 1032 is used to temporarily retain various programs and necessary data. The CPU 1031 executes the programs stored in the volatile memory 1032, thereby executing various processes of the entire storage node 103, as to be described later.

The storage device 1033 includes one or a plurality of types of large-capacity non-volatile storage devices such as a solid state drive (SSD), a serial attached small computer system interface (SCSI) (SAS) hard disk drive, and a serial advanced technology attachment (ATA) (SATA) hard disk drive. The storage device 1033 provides a physical storage area for reading or writing data in response to an I/O request from the host device 101.

The communication device 1034 is an interface for the storage node 103 to communicate with the host device 101, another storage node 103, or the management node 104 via the network 102. The communication device 1034 includes, for example, an NIC and an FC card. The communication device 1034 executes protocol control during communication with the host device 101, the other storage node 103, or the management node 104.

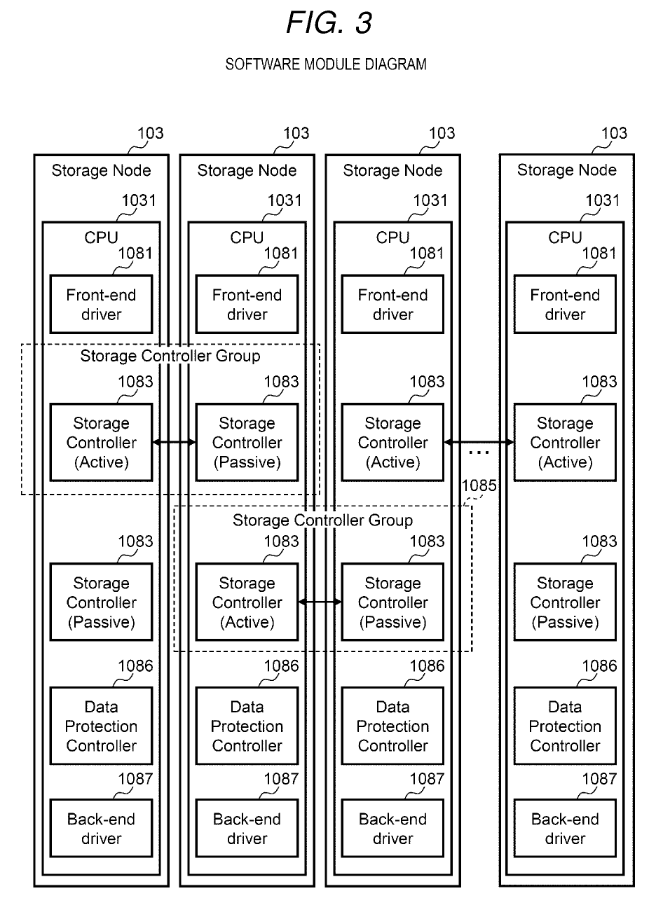

FIG. 3 is a diagram illustrating an example of a logical configuration of the storage node 103.

The storage node 103 includes a front-end driver 1081 (Front-end driver), a back-end driver 1087 (Back-end driver), one or a plurality of storage controllers 1083 (Storage Controller), and a data protection controller 1086 (Data Protection Controller).

The front-end driver 1081 is software that has a function of controlling the communication device 1034 and providing the CPU 1031 with an abstracted interface for the storage controller 1083 when the storage controller 1083 communicates with the host device 101, another storage node 103, or the management node 104.

The back-end driver 1087 is software that has a function of controlling each storage device 1033 in the own storage node 103 and providing the CPU 1031 with an abstracted interface when the CPU 1031 communicates with each storage device 1033.

The storage controller 1083 is software that functions as a controller for an SDS. The storage controller 1083 receives the I/O request from the host device 101 and issues an I/O command corresponding to the I/O request to the data protection controller 1086. In addition, the storage controller 1083 has a logical volume configuration function. The logical volume configuration function associates a logical chunk constituted by the data protection controller 1086 with a logical volume to be provided to the host. For example, a straight mapping method (a logical chunk and a logical volume are associated at a ratio of 1:1 and an address of the logical chunk and an address of the logical volume are the same) and a virtual volume function (Thin Provisioning) method (a method in which a logical volume and a logical chunk are divided into small size areas (pages) and addresses of the logical volume and the logical chunk are associated with each other in units of pages) may be adopted.

In a case of Embodiment 1, each storage controller 1083 installed in the storage node 103 is managed, together with another storage controller 1083 disposed in another storage node 103, as a group constituting a redundancy configuration. Hereinafter, this group is referred to as a storage controller group 1085.

FIG. 3 illustrates a case in which one storage controller group 1085 includes two storage controllers 1083. In the following, the description will be made assuming that the storage controller group 1085 includes two storage controllers 1083, but one redundancy configuration may include three or more storage controllers 1083.

In the storage controller group 1085, one storage controller 1083 is set to a state (a state of an active system, hereinafter referred to as an active mode) in which the one storage controller 1083 can receive the I/O request from the host device 101. In addition, in the storage controller group 1085, the other storage controller 1083 is set to a state (a standby system state, hereinafter referred to as a standby mode) in which the other storage controller 1083 cannot receive the I/O request from the host device 101.

In the storage controller group 1085, when a failure occurs in the storage controller 1083 set to the active mode (hereinafter, referred to as an active storage controller) or the storage node 103 in which the active storage controller is disposed, the state of the storage controller 1083 set to the standby mode until then (hereinafter, referred to as a standby storage controller) is switched to the active mode. Accordingly, when the active storage controller cannot operate, an I/O process executed by the active storage controller can be taken over by the standby storage controller.

The data protection controller 1086 is software that has a function of allocating a physical storage area provided by the storage device 1033 in the own storage node 103 or the other storage node 103 to each storage controller group 1085, and reading or writing designated data from or to the corresponding storage device 1033 in response to the I/O command provided by the storage controller 1083.

In this case, when the physical storage area provided by the storage device 1033 in the other storage node 103 is allocated to the storage controller group 1085, the data protection controller 1086 read or write the data from or to the storage area in response to an I/O command provided by the active storage controller of the storage controller group 1085 by cooperating with the data protection controller 1086 installed in the other storage node 103 and exchanging data with the other data protection controller 1086 via the network 102.

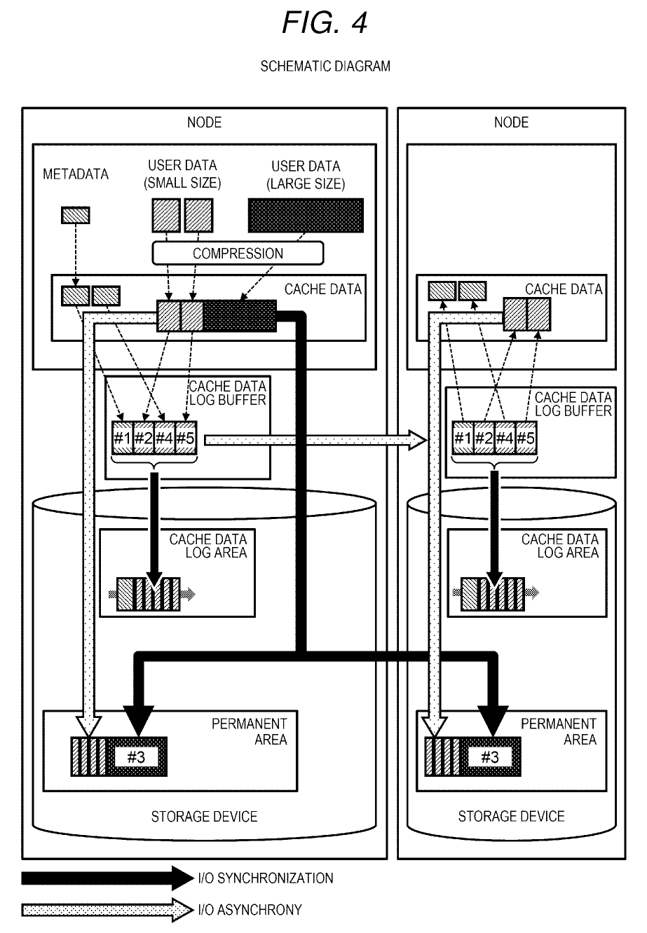

FIG. 4 is a diagram illustrating an outline of the disclosed storage system and a disclosed storage control method.

The storage controller 1083 updates cache data for write I/O from the host. At this time, user data may be processed by a function provided by the storage controller 1083. In the present embodiment, a case where a compression function is provided is illustrated as an example, and user data sent from the host is compressed and written as cache data. In an application of the present embodiment, the compression function may not be provided, and in this case, the user data is written to the cache data without being compressed.

When the compression function is applied or when a function such as thin provisioning or snapshot is provided, control information (metadata) related to the user data is typically generated. This metadata also needs to be protected in the same manner as the user data, and thus needs to be stored in a storage device with redundancy. In the present embodiment, the metadata is also updated as cache data in the same manner as the user data.

In the invention, two types of methods are used for redundancy and non-volatility of data updated as cache data.

One method is to update the cache data, generate a cache data log in a cache log buffer, transmit the cache data log to another node in I/O synchronization (that is, before responding to the host with a success), write the cache data log to a cache data log area on a storage device in both the own node and the other node for protection, and write (destage) the cache data to a permanent area in I/O asynchronous (that is, after responding to the host). This method is called a write-back method. An update log on a log buffer is written in the append format in a log area on the storage device. This writing may be executed immediately or collectively.

The other method is to update the cache data and write (destage) the cache data to the permanent area in I/O synchronization. This method is called a write-through method. In this case, the cache data log is not generated.

Writing to the permanent area is executed by the data protection controller 1086. In this case, data may be set redundant by a mirroring method in which redundancy is executed by copying the same data to another node or an Erasure Coding method in which redundancy is executed by adding a redundancy code (parity) generated from a plurality pieces of data.

In order to maintain consistency between the cache data log of the metadata written as the cache data or the user data written by the write-back method and the user data written to the permanent area by the write-through method, the storage controller 1083 assigns a common sequence number to both the cache data log of the write-back method and the data written by the write-through method in the order in which the data is written from the host 101 to the logical volume ("#1", "#2", and the like in the drawing). The sequence number is order guarantee information. Regarding a method of storing the sequence number assigned to the user data written to the permanent area, an example of storing the sequence number as a write-through log header list to be described later is illustrated in the present embodiment, but a different method as illustrated in Embodiment 2 or other methods may be used.

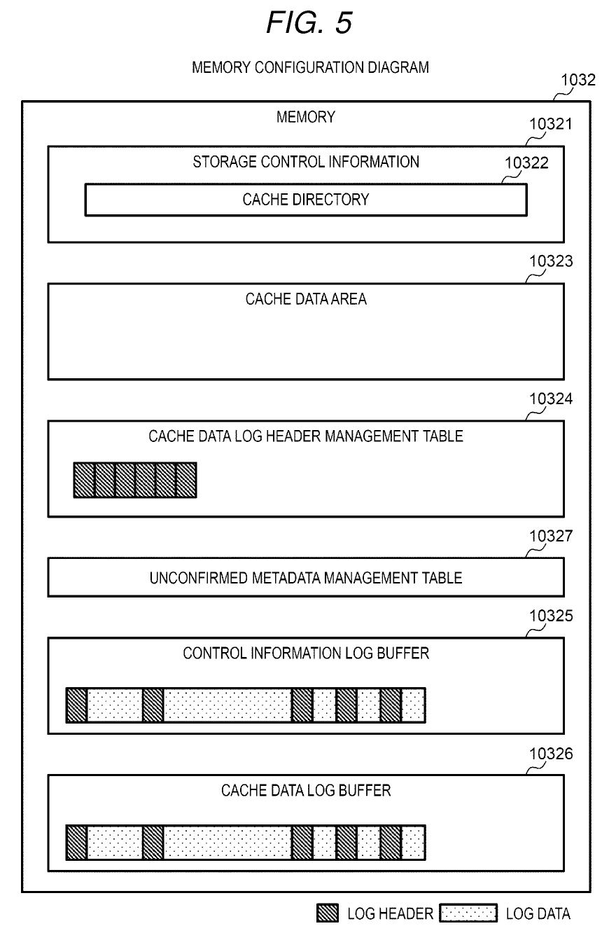

FIG. 5 is an example of a configuration diagram of the memory. The memory stores storage control information 10321, a cache data area 10323, a cache data log header management table 10324, an unconfirmed metadata management table 10327, a control information log buffer 10325, and a cache data log buffer 10326.

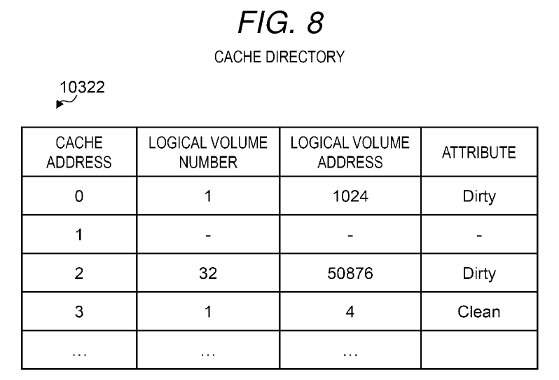

The storage control information 10321 is an area in which control information for implementing various storage functions is stored, and includes, for example, a cache directory 10322. The cache directory 10322 will be described with reference to FIG. 8.

The cache data log header management table 10324 is a table that stores log headers of all cache data logs on a disk.

The unconfirmed metadata management table 10327 is a table for managing whether there is an unconfirmed update of metadata related to user data.

The control information log buffer 10325 temporarily retains a control information log. The cache data log buffer 10326 temporarily retains a cache data log.

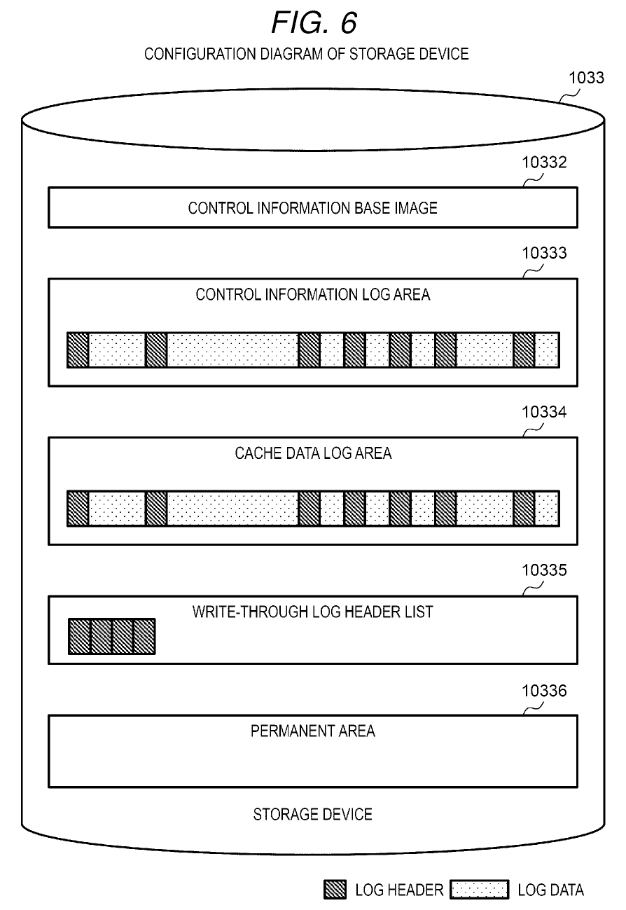

FIG. 6 is an example of a configuration diagram of the storage device. The storage device includes a control information base image area 10332, a control information log area 10333, a cache data log area 10334, a write-through log header list 10335, and a permanent area 10336.

The control information base image area is an area for copying the entire control information. The control information log area 10333 and the cache data log area 10334 are each a destination area in which a log is saved in a log saving process to be described later. The write-through log header list 10335 is used in a write-through process to be described later. The permanent area 10336 is an area for storing user data, which is managed by the data protection controller 1086.

Each of the areas will be described in process flows to be described later.

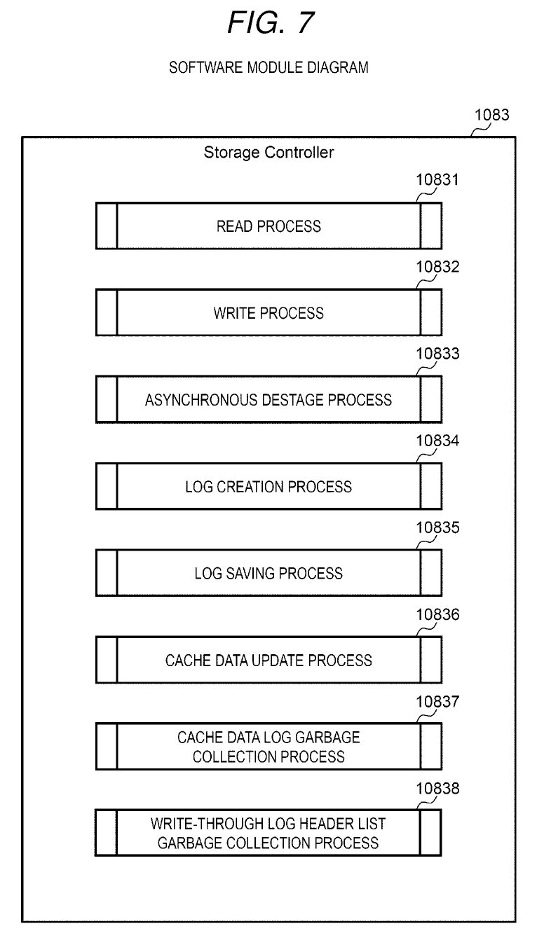

FIG. 7 is a diagram illustrating an example of a software module structure of the storage controller 1083.

The storage controller 1083 executes a read process 10831, a write process 10832, an asynchronous destage process 10833, a log creation process 10834, a log saving process 10835, a cache data update process 10836, a cache data log garbage collection process 10837, and a write-through log header list garbage collection process 10838. Details of each process will be described later.

Hereinafter, the control information will be described.

FIG. 8 is a diagram illustrating an example of the cache directory 10322. The cache directory 10322 is management information of areas (cache segments) obtained by subdividing a cache area, and has entries corresponding to the cache segments respectively.

Each entry includes a cache address, a logical volume number, a logical volume address, and an attribute entry. The cache address indicates an address on the memory of the cache segment corresponding to each entry, and the logical volume number and the logical volume address indicate which logical volume and which address data stored in the cache segment belongs to. When no data is stored in the cache segment, "-" indicating "no value" is stored. When data is stored in the cache segment, an attribute field has a value of "Dirty" or "Clean". "Dirty" indicates that the data is not destaged and is not written to the storage device, and "Clean" indicates that the data is destaged and matches a value written to the storage device.

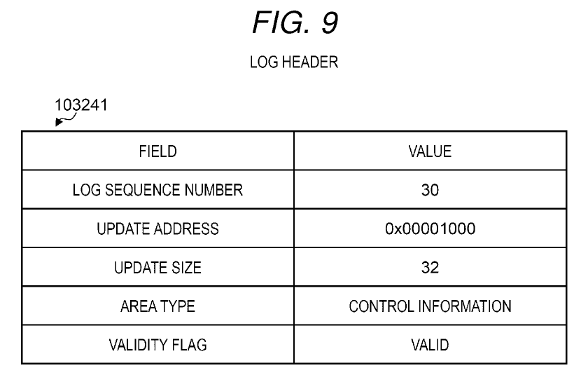

FIG. 9 illustrates a structure of a log header 103241. The log header 103241 is a table included in each log stored in a log buffer area on the memory or the log area on the storage device.

Each log header includes fields of a log sequence number, an update address, an update size, an area type, and a validity flag.

The log sequence number field stores a log sequence number uniquely assigned to each log. The update address field stores an address of control information or cache data of each log, which is an update target. The update size field stores a size to be updated. The area type field stores a value for identifying either the control information or the cache data. Here, it is assumed that a character string of "control information" or "cache data" is stored. In the validity flag field, a value of "valid" or "invalid" is set.

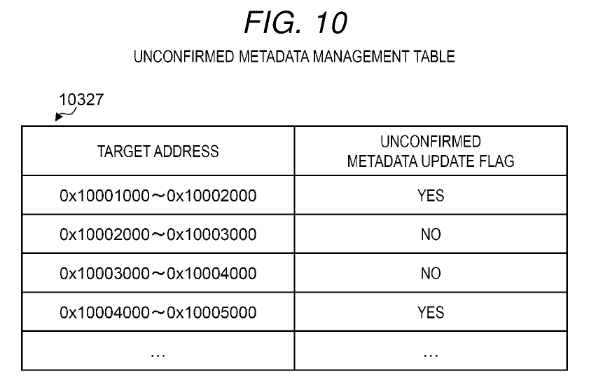

FIG. 10 illustrates a structure of the unconfirmed metadata management table 10327. The unconfirmed metadata management table 10327 is a table for managing whether metadata corresponding to an address range of each piece of user data has been updated. Each entry includes a target address field and a related metadata update flag field. When the metadata related to the address range indicated in the target address field is updated and the update is not confirmed, a value of the related metadata update flag field is set to "Yes", otherwise it is set to "No".

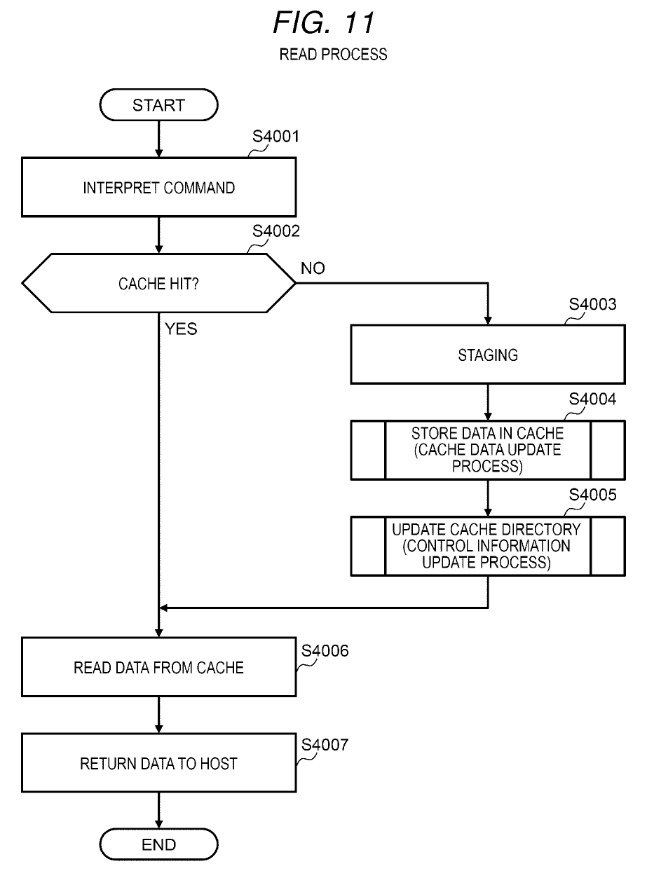

FIG. 11 is an example of a flowchart of the read process 10831. The read process 10831 is called when a read I/O command is received from the host, and executed by the storage controller 1083. First, a read command transmitted from the host is received via a front-end driver, and the read command is interpreted to obtain a logical volume number and a logical volume address of a read target (step 4001).

Next, it is determined whether a cache hit is present (step 4002). Specifically, the cache directory 10322 is referred to, and an entry corresponding to the logical volume number and the logical volume address is searched for in the cache directory 10322. If the entry is present (hit), the cache address is referred to from the entry, the process proceeds to branch Yes, data is read from the cache area (step 4006), and the data is returned to the host (step 4007). If no entry corresponds to the logical volume number and the logical volume address in the cache directory 10322 (miss), the process proceeds to branch No, and a staging process is called (step 4003). The staging process is a process executed by the data protection controller 1086, and in the staging process, data corresponding to the logical volume number/the logical volume address is read from a permanent area on the storage device. The read data is stored in a cache data area on the memory (step 4004). At this time, the cache data update process 10836 to be described later is called by setting necessity of non-volatility to "unnecessary". The cache directory 10322 is updated (step 4005). At this time, the cache directory 10322 is one piece of the control information, and thus a control information update process to be described later is called. At this time, the control information update process is called by setting the necessity of non-volatility to "unnecessary" in the same manner as the cache data update process. Then, as in the case of the cache hit, the data is read from the cache (step 4006) and the data is returned to the host (step 4007).

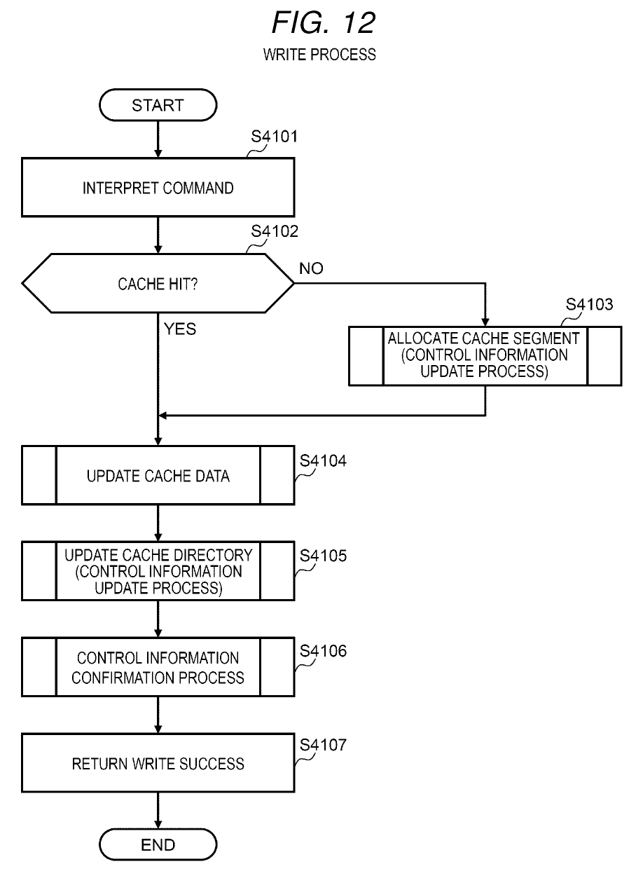

FIG. 12 is an example of a flowchart illustrating the write process 10832. The write process 10832 is executed by the storage controller 1083. First, a write command transmitted from the host is received via the front-end driver, and the write command is interpreted to obtain a logical volume number and logical volume address of a write target (step 4101). Next, it is determined whether a cache hit is present (step 4102). Specifically, the cache directory 10322 is referred to, and an entry corresponding to the logical volume number and the logical volume address is searched for in the cache directory 10322. If the entry is present (hit), the cache address is referred to from the entry, the process proceeds to branch Yes, and the data is stored in the cache (step 4104). At this time, the cache data update process 10836 to be described later is called by setting the necessity of non-volatility to "necessary". Next, the corresponding cache directory 10322 is updated (step 4105). At this time, the cache directory 10322 is one piece of the control information, and thus the control information update process to be described later is called. At this time, the control information update process is called by setting the necessity of non-volatility to "necessary" in the same manner as the cache data update process. Next, a control information confirmation process to be described later is called (step 4106). Finally, a write success is returned to the host (step 4107).

In a case of a cache miss, the process proceeds to branch No, the cache segment is allocated (4103), and the control information update process is also called to allocate the cache segment. At this time, the necessity of non-volatility is set to necessary. Thereafter, the process proceeds to step 4104, and subsequent steps are the same as the case of hit.

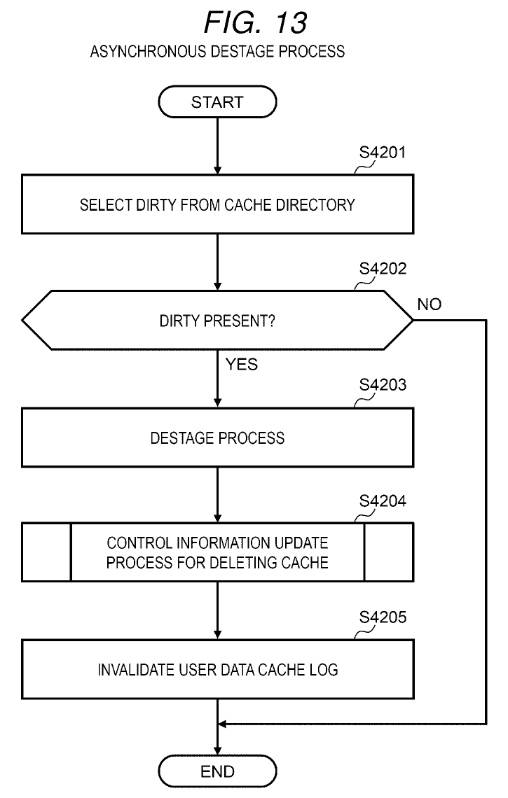

FIG. 13 is a flowchart of the asynchronous destage process 10833. In the asynchronous destage process 10833, an entry whose attribute is "Dirty" is searched for from the cache directory 10322 (step 4201), and the process ends when no such entry is present (branch No). When the entry of "Dirty" is present (branch Yes), a destage process is executed on the cache segment (step 4203). The destage process is a process executed by the data protection controller 1086, and data corresponding to the logical volume number/the logical volume address is written to the permanent area on the storage device. At this time, data may be redundantly stored using a technique such as mirroring or erasure coding (EC). Thereafter, the entry is deleted from the cache directory 10322 (step 4204). At this time, since the cache directory is updated, the control information update process is called and updated by setting the necessity of non-volatility as necessary. Next, a user data cache log is invalidated (step 4205). This process is a process of searching for the cache data log header management table 10324 and invalidating the user data cache log in the same address range as that of the data destaged in this process.

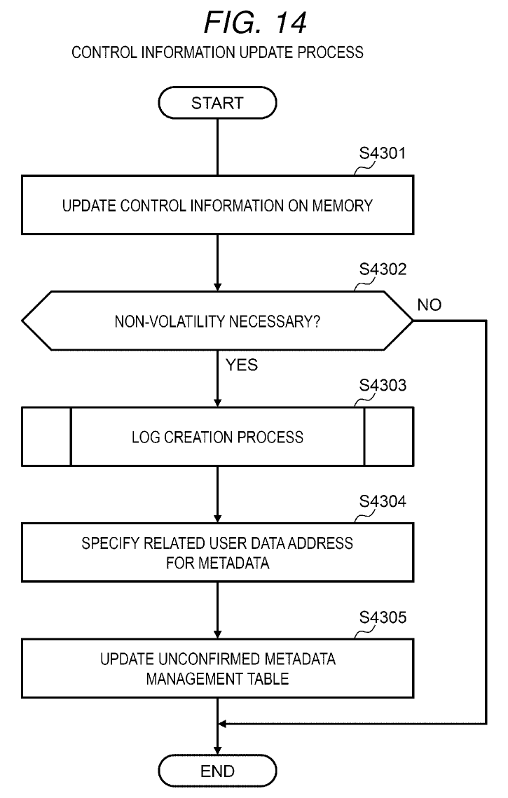

FIG. 14 is a flowchart of the control information update process. The control information update process is called when the control information on the memory is updated. When the control information update process is called, a memory address and a size for specifying the control information that is the update target, an update value, and information indicating the necessity of non-volatility are passed.

First, in the control information update process, the control information on the memory is updated (step 4301). Next, the necessity of non-volatility is determined with reference to the passed necessity of non-volatility (step 4302). Only when the non-volatility is necessary, the log creation process 10834 is called (4303). Next, a related user data address for the control information (metadata) that is the update target is specified (step 4304). In this specification method, for example, if the metadata is the cache directory 10322 in FIG. 8, a value of a cache address field of the entry to be updated is the related user data address. There may be a plurality of related user data addresses. For example, if the control information update process is an update in which the metadata is control information related to the entire volume, the entire user data address range belonging to the volume may be used as the related user data address. Finally, the value of the related metadata update flag field of the entry belonging to the range of the related user data address and the target address field on the unconfirmed metadata management table is set to "Yes" (step 4305).

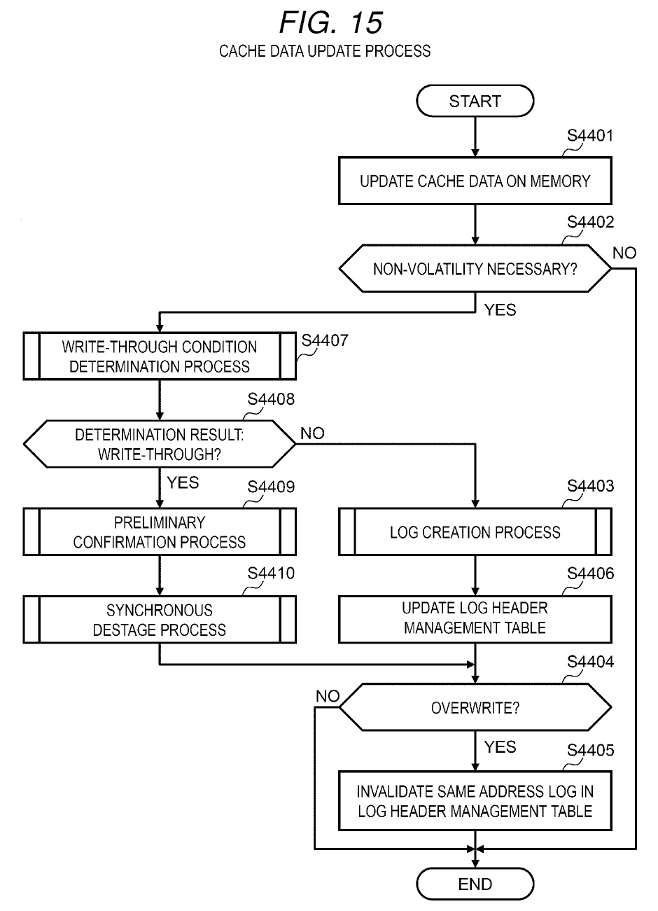

FIG. 15 is a flowchart of the cache data update process 10836. Steps 4401 to 4403 are the same as steps 4301 to 4303 except that the update target is the cache data instead of the control information.

In the cache data update process 10836, when it is determined in step 4402 that non-volatility is necessary, first, a write-through determination process is called (step 4407). The process branches depending on a determination result (step 4408), and if the determination result is Yes, a preliminary confirmation process (step 4409) is executed, and then a synchronous destage process (step 4410) is executed, and the process proceeds to step 4404. If the determination result in step 4408 is No, the process proceeds to step 4403, and then a log header of a log created in step 4403 is added to a log header management table (step 4406), and the process proceeds to step 4404.

In step S4404, it is determined whether to overwrite the cache data. That is, the cache data log header management table is referred to, and whether a log of the same address is present is searched for. If the log of the same address is present, it is determined to overwrite the cache data. Only when the cache data is overwritten, the log of the same address in the cache data log header management table is invalidated (step 4405). Invalidating the log is a process of setting the validity flag in the log header management table to "invalid".

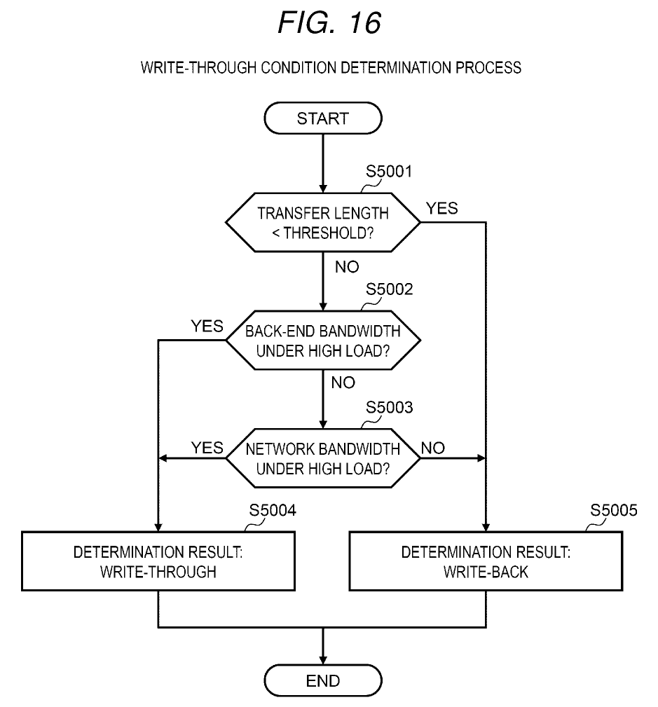

FIG. 16 is a flowchart of a write-through condition determination process. First, if a transfer length of a target write I/O is equal to or less than a threshold (step 5001), write-back is determined (proceeding to step 5005). Otherwise, if a back-end bandwidth is under a high load (step 5002) or if a network bandwidth is under a high load (step 5003), write-through is determined (step 5004), and if neither of these cases is possible, the write-back is determined (step 5005).

A write-through condition is not limited to the example in FIG. 16, and can be set to any condition. For example, a cache hit rate of the user data may be used as the condition, and a write-through operation may be selected if the cache hit rate is smaller than a predetermined threshold.

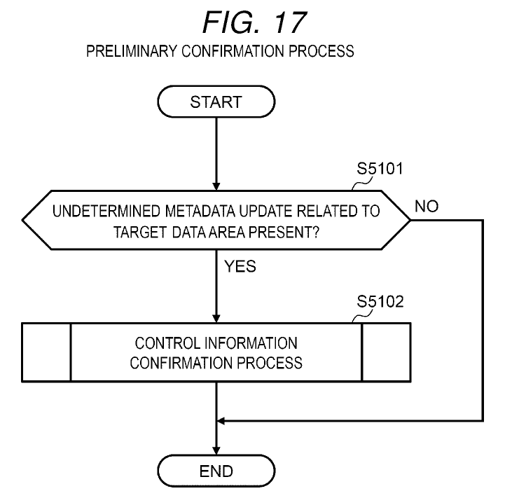

FIG. 17 is a flowchart of a preliminary confirmation process.

In the preliminary confirmation process, it is determined whether an unconfirmed metadata update related to a target user data area is present using the unconfirmed metadata management table 10327 illustrated in FIG. 10 (step 5101), the control information confirmation process is called if a determination result is Yes (step 5102), and the process ends without doing anything if the determination result is No.

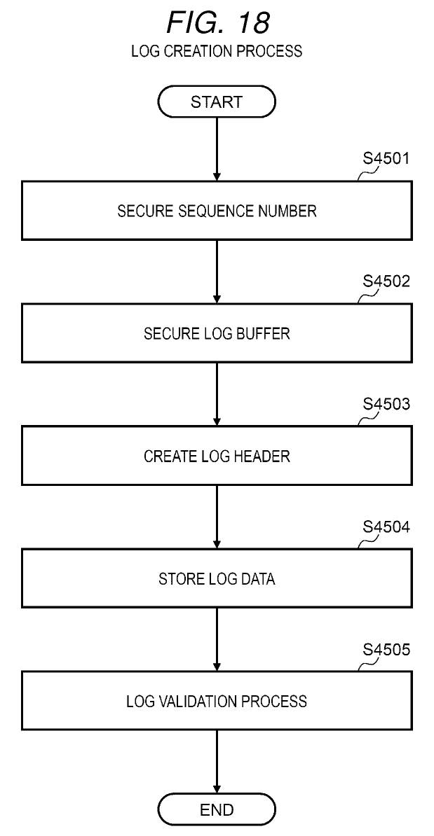

FIG. 18 is a flowchart of the log creation process 10834. In the process, the "log buffer" indicates the control information log buffer when the update target is the control information, and indicates a user data cache log buffer when the update target is user data cache.

First, a log sequence number is determined (step 4501). The log sequence number is a number that is assigned in an order of log creation and in which one log always corresponds to one log sequence number. Next, an area to which the log is next written is allocated in the log buffer (step 4502).

The log creation process 10834 may be executed by a plurality of processes operating in parallel, but in this case, it is necessary to execute an exclusion process such that the same log sequence number is not acquired by another process and the same log buffer area is not allocated by another process.

Next, the log header is created (step 4503). The above-described log sequence number is stored in the log sequence number field of the log header, and values of the update address and the update size on the memory, which are passed in the log creation process 10834, are stored in the update address field and the update size field, respectively. The area type field stores "control information" when the control information is updated, and stores "cache data" when the cache data is updated.

Next, the log is stored in the log buffer (step 4504). The log includes the log header and the update data itself. The log header is stored at a head of a allocated area previously allocated on the log buffer, and the updated data itself is stored at a memory address obtained by adding a log header size to the allocated area.

Finally, the validity flag in the log header is set to "valid" (step 4505), and the process ends.

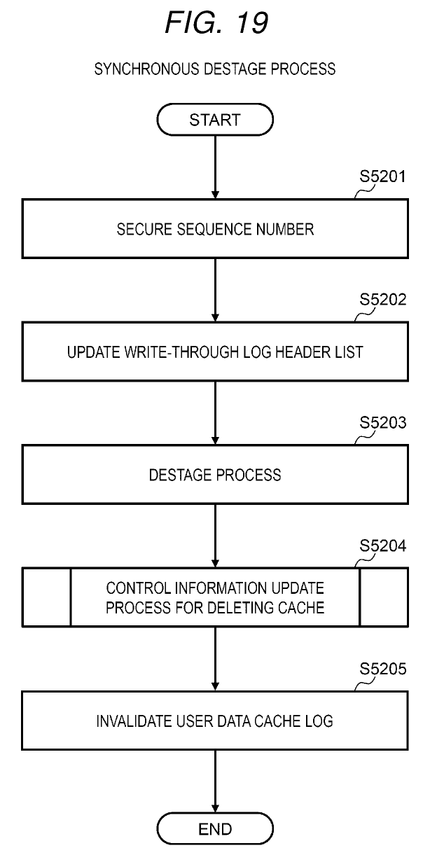

FIG. 19 is a flowchart of a synchronous destage process. First, a sequence number is allocated (step 5201). This sequence number allocation is the same process as step 4501 in the log creation process 10834 in FIG. 18. Next, the write-through log header list 10335 is updated (step 5202). Specifically, a "write-through log header" related to write-through data is added to the write-through log header list 10335. The write-through log header is a log header in which the area type is set to "write-through" in a log header format illustrated in FIG. 9, and includes only the log header and does not include a data portion.

The subsequent steps 5203 to 5205 are the same as steps 4203 to 4205 in the asynchronous destage process 10833 in FIG. 13.

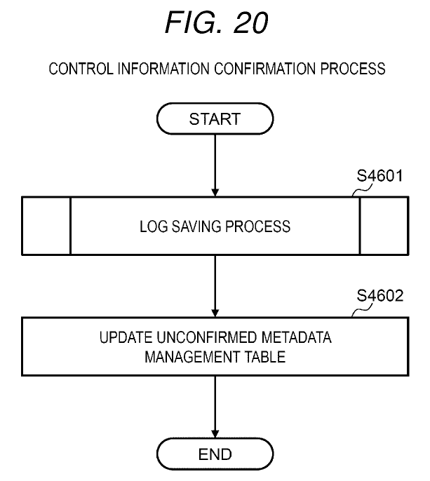

FIG. 20 illustrates the control information confirmation process. In this process, the log saving process 10835 is called (step 4601), and then the unconfirmed metadata management table 10327 is updated (step 4602). Specifically, regarding a control information log among the logs that have been written to the storage device in step 4601, the user data address related to the control information is specified (for example, specified by executing the same process as in step 4304 in FIG. 14), and the value of the related metadata update flag field of the entry in which this address belongs to the range of the target address field of the unconfirmed metadata management table 10327 is set to "No".

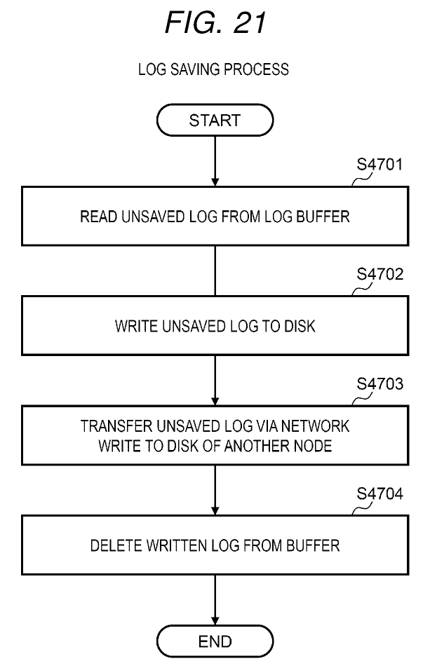

FIG. 21 illustrates a processing flow of the log saving process 10835. First, the log buffer is referred to, and an unsaved log is read (step 4701). Next, the unsaved log is stored in the log area on the storage device (step 4702). Further, the unsaved log is transferred to another node through the network and stored in the log area on the storage device of the other node (step 4703). A writing position is immediately after the last written log.

When the writing is completed, the log on the memory is deleted from the log buffer (step 4704).

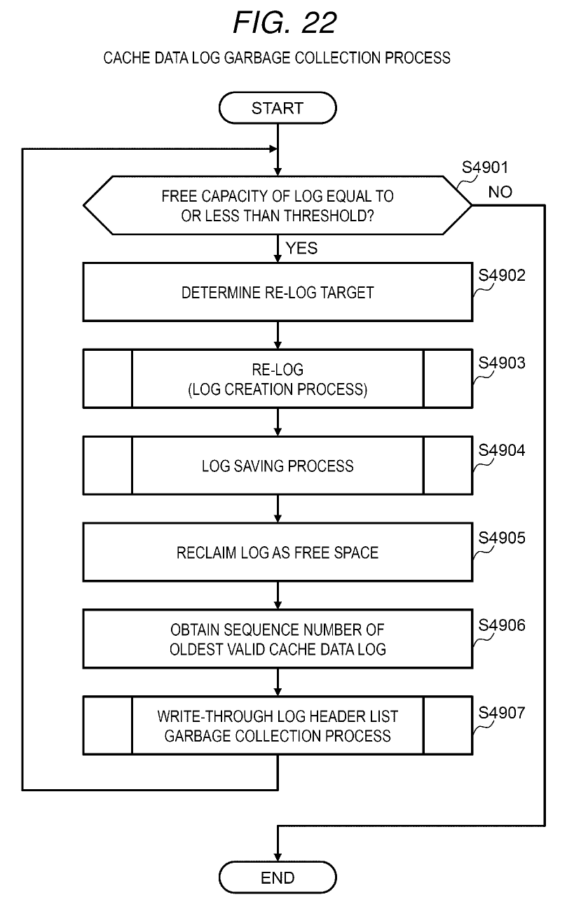

FIG. 22 is a flowchart of the cache data log garbage collection process 10837. First, it is determined whether a free capacity of the cache data log is equal to or less than a threshold (step 4901), and if the free capacity of the cache data log is not equal to or less than the threshold, the process ends without doing anything. If the free capacity is equal to or less than the threshold, the cache data log header management table 10324 on the memory is referred to, searching is executed forward from the oldest cache log header (the smallest log sequence number) among cache log headers, and the oldest valid log whose validity flag value is "valid" is obtained (step 4902). When the oldest valid log is specified in the cache data log area, a log of data indicating the log is newly created (step 4903). At this time, a new log sequence number may be allocated and reassigned. Next, when the log saving process is called and the log is written to the storage device (4904), an area having an address lower than that of the log including the log in the log area is reclaimed as a log free space (step 4905). Next, the sequence number of the newly oldest valid cache data log is obtained (step 4096). Then, a garbage collection process of the write-through log header list 10335 is executed using the sequence number (step 4907).

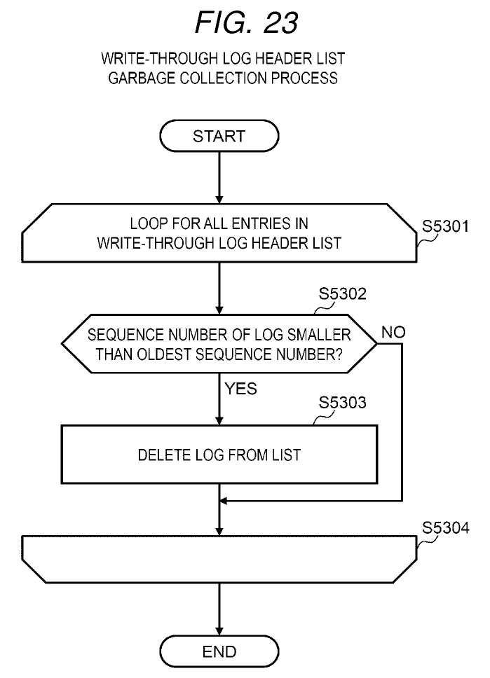

FIG. 23 is a flowchart of the write-through log header list garbage collection process 10838. This process is a loop for sequentially searching the write-through log header list 10335 from a head, and repeats steps 5302 to 5303. In each loop, first, it is determined whether the sequence number of the log is smaller than the oldest sequence number obtained in step 4096 in FIG. 22 (step 5302). If a determination result is Yes (smaller), the log is invalidated (deleted from the list) (step 5303). If the determination result is No, nothing is executed.

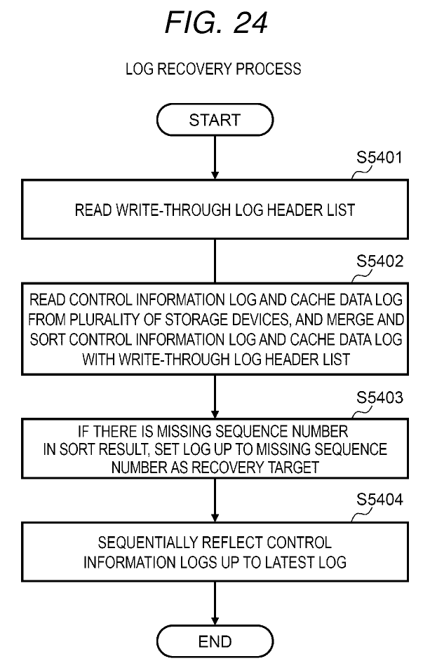

FIG. 24 is a flowchart of a log recovery process. This function is called before the storage controller 1083 is activated upon reactivation after power interruption. At this time, cache data related to a write-back process stored in the memory is lost due to the power interruption. Therefore, it is necessary to recover the cache data log that is responded to the host (not retransmitted from the host) and is not destaged to the storage device 1033. First, the write-through log header list 10335 is read (step 5401). Next, the cache data log is read from the storage device, the cache data log and the log header included in the write-through log header list 10335 are merged while being sorted according to the sequence number, and the oldest log (log having the smallest sequence number) to the newest log (log having the largest sequence number) are arranged (step 5402).

Here, if there is a missing sequence number in the sequence number in the arranged log group, the log up to the missing sequence number is set as a recovery target (latest log used in subsequent step 5404) (step 5403). In this way, if there is data that is not written by write-through, a log to be written after the writing (such as a log whose sequence number is a number after the missing data) is not used for cache recovery. This is to prevent the data written later from being recovered although the data written earlier between the cache data is not recovered.

A reason why such recovery in the order of writing between pieces of cache data is required at the time of log recovery will be described. A problem is, for example, a case where data written later is metadata referring to data written earlier (not only data written by the host but also metadata created by the storage controller). At the time of recovery after the power interruption, a log of the former data is not present (a sequence number of the log seems to be missing), but a log of the latter metadata may be present. At this time, if the latter metadata is recovered from the log, the former data referred to by the metadata cannot be recovered, and thus becomes old data or invalid data, but the latter metadata refers to the former data. That is, after the log is recovered, the metadata and the data do not match. Therefore, it is possible to execute recovery while maintaining consistency between the data and the metadata on the memory by setting the log up to the missing sequence number as the recovery target as in step 5403 and ensuring that there is no missing sequence number in the range of the logs to be recovered.

Hereinafter, the oldest log to the latest log (the latest log of the recovery target determined in step 5403) are reflected in the respective areas of the control information and the cache data on the memory in that order based on the address of the log (step 5404). Since the log included in the write-through log header list is only the log header, the reflection process is not executed (since the log is already written to the permanent area by write-through, the reflection process in the memory is not necessary). In this way, the recovery of the control information/the cache data after the power interruption is completed.

There may be a method in step 5403 in which, if there is a missing sequence number, a log of the missing number is skipped and the subsequent log is recovered from the data in the memory, but in this case, as described above, the data in the memory and the metadata may be in an inconsistent state, and therefore, it is necessary to separately manage that the data in the area is invalid in order to prevent the host from writing the data again after the recovery from the power interruption so that the data is read without being recovered and invalid data is returned.

In the present embodiment, in a situation where a drive or a network bandwidth may be strained, such as when a write I/O having a large transfer length is applied with a high load, a write-through operation is executed, that is, data is not non-volatile as cache data, but is directly written to a permanent area for final storage and is non-volatile, and then responds to a host, so that total traffic to a drive network per write I/O can be reduced, thereby improving maximum throughput performance.

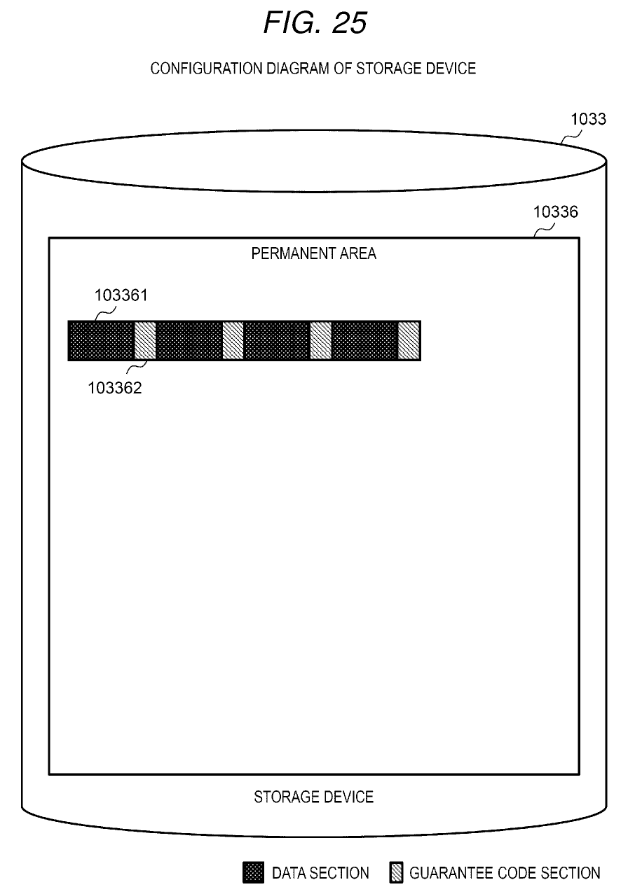

FIG. 25 is an example in which the sequence number assigned to the data stored by the write-through method is retained by a method different from the write-through log header list 10335.

In this figure, areas other than the permanent area are not illustrated.

The present embodiment is an example in which data in the permanent area is stored as a set of a data section and a guarantee code section corresponding the data section. The guarantee code section stores a guarantee code (a value calculated using LRC, CRC, or the like) calculated from the data section and a unique value obtained from a volume number or an address, and is used to detect a case where different data at an address in which bit destruction has occurred in the data is erroneously written. The guarantee code section may store the sequence number. In this example, the step 5301 (loop process) is also changed in the write-through log header list garbage collection process in FIG. 23, and the list is not searched from the head, but the permanent area is searched to refer to the guarantee code section of each user data. When the determination in step 5302 is Yes, the invalidation process in step 5303 is a process of rewriting a sequence number area of the guarantee code section of the user data to an invalid value.

As described above, the storage system 100 disclosed in the embodiment includes: the non-volatile storage device 1033; the storage controller 1083 configured to process reading and writing of data and to input and output the data to and from the storage device; and the volatile memory 1032. Upon receiving a write request for data from the host, the storage controller 1083 selectively executes a write-back operation of creating a cache data log of the data related to the write request, writing the cache data log to a log area on the storage device, responding to the host, and destaging the cache data log to a permanent area on the storage device, and a write-through operation of destaging the data related to the write request to the permanent area on the storage device without writing the cache data log to the storage device, and then returning a response to the host, common order guarantee information is assigned to the cache data log in the write-back operation and to the data related to the write request in the write-through operation, and the cache data log in the memory is recovered using the order guarantee information when recovering from power interruption.

According to this configuration and operation, the storage system 100 can implement a storage system having both high performance and high reliability.

As an example, the storage controller 1083 provides, in the storage device 1033, a write-through management area different from the permanent area, and stores the order guarantee information of the data destaged by the write-through operation in the write-through management area.

As an example, the storage controller 1083 stores the data destaged by the write-through operation in the permanent area on the storage device 1033 in association with the order guarantee information.

Accordingly, the order guarantee information may be stored in any format.

In addition, when new writing to the permanent area is to be executed, if there is other data for which writing to the storage device is not completed, the storage controller 1083 executes the new writing after completing the writing of the other data.

Specifically, the storage controller 1083 provides, in the memory, the unconfirmed metadata management table for managing whether there is an unconfirmed update of the metadata related to the user data, and specifies the other data with reference to the unconfirmed metadata management table.

According to this configuration and operations, the storage system 100 can prevent the new writing from overtaking writing that is not completed, and can maintain the order.

In addition, the order guarantee information is sequence numbers, and when a log recovery process is called upon reactivation after power interruption, the sequence numbers are sorted, and if there is a missing sequence number in the sorted sequence numbers, a log related to writing executed before the missing sequence number is set as a recovery target.

According to this configuration and operation, the storage system 100 can execute the recovery process while maintaining the consistency between the write-through operation and the cache data.

As an example, the storage controller 1083 selects the write-back operation when a transfer length of data related to writing is shorter than a threshold, selects the write-back operation when a back-end bandwidth and a network bandwidth are under a low load, and selects the write-through operation when a transfer length of data related to writing exceeds a threshold and the back-end bandwidth or the network bandwidth is under a high load.

As an example, the storage controller 1083 selects the write-back operation or the write-through operation according to a cache hit rate of data related to writing.

According to this configuration and operation, the write-through operation and the write-back operation are selectively used according to a load related to the writing, and the consistency can be ensured by the order guarantee information even when the write-through operation is adopted.

The storage system according to the invention will be briefly described as follows. The storage system employs an operation (write-through operation) of writing data to the permanent area on the storage device and then returning the response to the host without creating the cache data log under a condition in which a decrease in write performance may occur, and appropriately uses an operation (write-back operation) of creating the cache data log, writing the cache data log to the log area on the storage device, and returning the response to the host, thereby reducing traffic to the storage device and the network bandwidth per write I/O. At this time, the metadata that needs to be added to the user data particularly by a compression function or the like adopts the write-back operation, but it is possible to non-volatilize the metadata written by the write-back operation and the user data written by the write-through operation in a state in which the consistency is maintained by assigning a common sequence number to the metadata and the user data and appropriately confirming prior write for updates having a dependency relation.

The invention is not limited to the above-described embodiment, and includes various modifications. For example, the above-described embodiment has been described in detail to facilitate understanding of the invention, and the invention is not necessarily limited to those including all the configurations described above. The configurations may not only be deleted, but also be replaced or added.

What is claimed is:

1. A storage system, comprising:
a non-volatile storage device;
a storage controller configured to process reading and writing of data and to input and output the data to and from the storage device; and
a volatile memory, wherein
upon receiving a write request for data from a host, the storage controller selectively executes
a write-back operation of creating a cache data log of the data related to the write request, writing the cache data log to a log area on the storage device, responding to the host, and destaging the cache data log to a permanent area on the storage device, and
a write-through operation of destaging the data related to the write request to the permanent area on the storage device without writing a cache data log to the storage device, and then returning a response to the host,
common order guarantee information is assigned to the cache data log in the write-back operation and to the data related to the write request in the write-through operation, and
the cache data log in the memory is recovered using the order guarantee information when recovering from power interruption.

2. The storage system according to claim 1, wherein
the storage controller provides, in the storage device, a write-through management area different from the permanent area, and stores the order guarantee information of the data destaged by the write-through operation in the write-through management area.

3. The storage system according to claim 1, wherein
the storage controller stores the data destaged by the write-through operation in the permanent area on the storage device in association with the order guarantee information.

4. The storage system according to claim 1, wherein
the order guarantee information is sequence numbers, and
when a log recovery process is called upon reactivation after power interruption, the sequence numbers are sorted, and if there is a missing sequence number in the sorted sequence numbers, a log related to writing executed before the missing sequence number is set as a recovery target.

5. The storage system according to claim 1, wherein
the storage controller
selects the write-back operation when a transfer length of data related to writing is shorter than a threshold,
selects the write-back operation when a back-end bandwidth and a network bandwidth are under a low load, and
selects the write-through operation when a transfer length of data related to writing exceeds a threshold and the back-end bandwidth or the network bandwidth is under a high load.

6. The storage system according to claim 1, wherein
the storage controller selects the write-back operation or the write-through operation according to a cache hit rate of data related to writing.

7. A storage control method for a storage system including a non-volatile storage device, a storage controller configured to process reading and writing of data and to input and output the data to and from the storage device, and a volatile memory, the storage control method comprising:
upon receiving a write request for data from a host, by the storage controller selectively executing
a write-back operation of creating a cache data log of the data related to the write request, writing the cache data log to a log area on the storage device, responding to the host, and destaging the cache data log to a permanent area on the storage device, and
a write-through operation of destaging the data related to the write request to the permanent area on the storage device without writing the cache data log to the storage device and then returning a response to the host;
assigning common order guarantee information to the cache data log in the write-back operation and to the data related to the write request in the write-through operation; and
recovering the cache data log in the memory using the order guarantee information when recovering from power interruption.
